(19) United States
(12) Patent Application Publication
(10) Pub. No.: US 2015/0325044 A1
(43) Pub. Date: Nov. 12, 2015

(54) SYSTEMS AND METHODS FOR THREE-DIMENSIONAL MODEL TEXTURING

(71) Applicant: Adornably, Inc., Los Angeles, CA (US)

(72) Inventor: Marc Adam LEBOVITZ, Tarzana, CA (US)

(21) Appl. No.: 14/707,313

(22) Filed: May 8, 2015

Related U.S. Application Data
(60) Provisional application No. 61/991,400, filed on May 9, 2014.

(51) Int. Cl. G06T 17/00; G06T 11/00

(52) U.S. Cl. CPC G06T 17/00; G06T 11/001

(57) ABSTRACT

Systems and methods for modifying texture maps of a 3D model. The systems and methods enable a user to change the surface texture of a target virtual object. A target virtual object may include an item of furniture. The surface texture may correspond to a fabric swatch including a patterned fabric. System and methods for generating a plurality of control point for a target virtual object are described. The plurality of control points may be used to generate a UV mapping.

### RELATED APPLICATION

This application claims the benefit of U.S. Provisional Application No. 61/991,400, filed on May 9, 2014, which is incorporated by reference in its entirety.

### TECHNICAL FIELD

This disclosure relates to computer graphics and three-dimensional model texturing.

### BACKGROUND

Three-Dimensional (3D) models are the mathematical representations of the surface geometry of objects and are used to create computer-rendered images of the objects from any angle. A 3D model may include polygonal mesh model. 3D models may be assigned one or more materials that govern how the surface of the model is rendered by a computer given lighting conditions. One aspect of a material applied to a model is the material's texture map, if one is given. The texture map comprises two parts: a two-dimensional image file and a UV mapping. The UV mapping governs with which set of pixels in the image file each face of a polygonal model is associated. The associated pixels provide colors for the face that are used in the computer rendering process to determine what the surface looks like in the resulting rendered image.

The traditional way to create a polygonal mesh model and generate a texture for it is for an artist to do so manually. The artist may design a model using modeling software, design a texture for the model, then must define a UV mapping that relates the texture image to the model by wrapping, stretching, or tiling it. The texture may be based on a photograph. When modeling and UV-mapping manually, the texture image used can be easily switched, but modeling manually does not generate realistic geometries and the final shading effect for the surface of the model is achieved by simulating lighting using the computer, which is usually not realistic. To create a photorealistic effect manually is a difficult process that requires significant time dedicated by a professional artist.

### SUMMARY

In general this disclosure describes techniques for modifying texture maps of a 3D model. In particular, this disclosure describes example techniques for changing the surface texture of a target virtual object. That is, this disclosure describes techniques that may be used to easily switch patterned images on a photorealistic texture map applied to an arbitrary 3D scanned mesh. In one example, in order to change the surface texture of the target virtual object to a new pattern, the systems and techniques described herein compute two things: (1) The UV mapping of the function φ for a virtual object at each of its vertex locations in R3 to a location in UV space: φ(x,y,z)=|u v|; and (2) a texture image corresponding to the UV mapping that results in an appropriate surface representation of the image pattern. The example techniques described herein provide a process for repeating a new texture image pattern across portions of an arbitrary 3D polygonal mesh model given a starting point and orientation while preserving shading captured in its original texture image and allowing the mesh to be non-uniformly scaled from the state it was in when its texture map was created.

Further, in some examples, areas of a textured, polygonal mesh model are given a new surface texture pattern by computing a new parameterization by selecting a basis in UV space by identifying an origin point in R3 on the surface and the vectors of the U and V gradients; selecting a scaling conversion between distances in UV space and distances in R3; constructing a set of control points on the surface of the polygonal mesh; applying an optimization-based method for automatically parameterizing the 3D model with minimal deformities using the control points created; constructing a single-channel shading image that captures the original texture map shading by converting the original image to HSV space, extracting the V channel, and for each face in the 3D model performing an affine warp on the related texture image pixels from their original image space location to the new image space location determined by the new parameterization; selecting a new texture image tile and establishing a scaling conversion for how its pixel dimensions relate to R3 dimensions; determining the bounding box of mapped UV positions in the new parameterization; scaling and repeating the image tile so that the entire bounding box is covered considering the differences in scale between the new texture image tile in image space and the parameterization scale as it relates to R3; converting each resulting scaled, tiled, texture image to HSV space; and compositing the V channel of the scaled, tiled texture image in HSV color space with the shading image, then converting the result back to RGB color space, to generate the final texture map image.

In accordance with some other examples, the 3D model is first separated into regions, each of which may either be homeomorphic to a disk and will be re-parameterized and re-textured, or a static region that will retain its portion of the original texture map image and parameterization.

In accordance with some other examples, a set of control points may be programmatically constructed on the surface of the polygonal mesh along a grid of isoparametric curves that substantially cover each non-static region's surface before applying an optimization-based technique for automatically parameterizing each non-static region.

In accordance with some other examples, the polygonal mesh model may either be uniformly or non-uniformly scaled before a new surface texture pattern is computed for regions of its surface.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a flow diagram depicting a process according to example techniques described herein.

FIG. 2 includes images illustrating an example un-textured mesh before modification and an exploded view of the un-textured mesh after being separated into regions.

FIG. 3A-3E includes images illustrating an example un-textured region of the mesh, the region with its originally-captured texture, the region with a new texture, the original parameterization of the region in UV space, and the new parameterization of the region in UV space.

FIG. 4 includes images of an example tile to be patterned across the mesh surface, the original texture image, the tiled, unshaded image, the scaled shading image T₂ₛ; and the final texture image T₃.

FIG. 5 is a conceptual diagram depicting a basis control point on the surface of a region of a mesh region with two faces.

FIG. 6 is a conceptual diagram depicting traversing a face in R3 along an isoparametric curve in the positive U direction from a basis control point CP_{B} to a new control point CP₁ on the edge of the current face according to example techniques described herein.

FIG. 7 is a diagram depicting determining the line of intersection according to techniques described herein.

FIG. 8 is a diagram depicting traversing a face in R3 along an isoparametric curve in the U direction according to techniques described herein.

FIG. 9 displays exemplary images of a scaled image tile Tₜₛ and an associated unshaded texture image T₁, including annotations describing image sizes and locations of key points.

FIG. 10 illustrates an example of changing fabric on 3D models of furniture.

FIG. 11 illustrates an example computing system configured to perform one or more of the techniques described herein.

FIG. 12 illustrates an example of applications configured to perform one or more of the techniques described herein.

FIG. 13 illustrates an example of processes configured to perform one or more of the techniques described herein.

FIG. 14 is a computer program listing illustrating example pseudo-code that may be used to construct a control point grid according to the techniques described herein.

FIG. 15 is a computer program listing illustrating example pseudo-code that may be used to intersect a ray with the border of a face according to the techniques described herein.

FIGS. 16A-16B is a computer program listing illustrating example pseudo-code that may be used to update gradients for a control point on an edge to lie on a neighboring face according to the techniques described herein.

FIG. 17 is a computer program listing illustrating example pseudo-code that may be used to convert a UV space location to an image space pixel location in a standard texture image according to the techniques described herein.

FIG. 18 is a computer program listing illustrating example pseudo-code that may be used to convert a UV space location to an image space pixel location in a tiled texture image according to the techniques described herein.

FIG. 19 is a computer program listing illustrating example pseudo-code that may be used to convert an image space location in a tiled texture image to a UV space location according to the techniques described herein.

### DETAILED DESCRIPTION

As used herein, unless used otherwise, the following terms and abbreviations may have, at least, the following meanings:

“φ” is the parameterization function that maps a coordinate in R3 to a texture coordinate in UV space. φ(x, y, z)=[u, v]=X⁻¹(x, y, z)

“X” is the inverse parameterization function that maps a texture coordinate in UV space to a coordinate in R3. X(u, v)=[x, y, z]=φ⁻¹(u, v)

“2D” means two-dimension(al);

“3D” means three-dimension(al);

“3D model” refers to a virtual object;

“Bounding box” means a rectangular region containing all points of interest. In 2D, it is written in the form [(x0, y0), (x1, y1)], where (x0, y0) is the minimum point and (x1, y1) is the maximum point;

“HSV space” means the color space wherein pixel colors are defined by their hue, saturation, and value components rather than the traditional red, green, blue color component breakdown in RGB color space;

“Image space” means the 2D space confined to the pixels in an image. Its origin is (0,0);

“Image tile” means an image that is meant to be repeated in a pattern to generate a surface texture;

“Isoparametric” means changing in a single dimension of parametric space while the value in the other dimension is held constant;

“Isoparametric curve” means a curve in R3 that has a parameterization that corresponds to a line in UV space that is unchanging in either the U or V dimension along the length of the curve;

“Non-static region” means a region of a virtual object that is intended to have its parameterization and texture image changed;

“Parametric space” means the 2D vector space whose coordinates correspond to coordinates in an image space. A mapping φ from a vertex position in R3 to parametric space defines how a texture image is mapped onto the surface of a virtual object. The parametric space's horizontal axis is referred to as U and its vertical axis as V;

“Parameterization” as a verb refers to determining a UV mapping for a polygonal mesh model or, as a noun, refers to the resulting UV mapping for a polygonal mesh model;

“R3” stands for a 3D vector space of real number positions along each axis and is used here to refer to world space;

“Rendering engine” means a software application, or the like, that computes pixel colors representing a view of a virtual scene given input polygonal mesh models, virtual lighting, and a virtual camera;

“RGB” means the color space wherein pixel colors are defined by their red, green, and blue values, respectively;

“Screen space” means the 2D vector space confined to the pixels displayed on the screen of a device such as a computer screen;

“Static region” means a region of a virtual object that is intended to retain its parameterization and the associated pixels of its texture image;

“Texture coordinate” means a position in UV space;

“Texture image” means an image representing the surface colors of a virtual object and against which a mesh is UV mapped through a parameterization;

“UV mapping” means the assignment of texture coordinates to each vertex of a polygon mesh in R3. It is used to map a texture image onto the surface of a virtual object. The parameterization of a point inside a face is interpolated from the associated vertices' parameterization values using the point's barycentric coordinates;

“UV space” refers to parametric space;

“Virtual model” refers to a virtual object;

“Virtual object” means a 3D polygonal mesh model represented in world space coordinates that simulates an image of a real-world object when rendered to a screen by a computer; and

“World space” means the 3D vector space within which the positions and orientations of 3D objects, cameras, and lighting are given for computer graphics rendering of virtual objects.

As described above, a traditional way to create a polygonal mesh model and generate a texture for it is for an artist to do so manually. Computer-rendered images of objects can be made to look more realistic by capturing the geometry of an object using a 3D scanner and by using image stitching of photographs to create texture map images for the objects' materials. The technique of photogrammetry can also reproduce both accurate 3D models and texture maps by using the photographs to generate a point cloud from which a polygonal mesh is approximated, then using the photographs again to stitch a texture together. Geometry from a 3D scanner or photogrammetry closely approximates actual geometry, often within a fraction of a millimeter, as opposed to hand-modeled geometry, which is less accurate. Texture images generated by image-stitching multiple photographs creates highly realistic surface colors using real-world lighting.

There are downsides, however, to the more photorealistic approaches of 3D scanning, image stitching, and photogrammetry. Making changes to the geometry or textures is far more difficult than in the hand-modeled case. Changing geometry requires changing the UV mapping, which is more difficult on meshes generated by a 3D scanner because of their complexity. Even simple non-uniform scaling is not possible without reassigning the UV mapping because it would otherwise stretch and warp the texture image on the surface of the mesh. Changing the texture image itself requires hand-painting the model in a 3D paint program, which is both slow and less apt to produce a realistic effect. For these reasons, making changes to these more realistic 3D models is avoided and instead new 3D models are acquired using the same techniques. For example, if a texture map for a model of a striped couch is created using a 3D scanner and image stitching, and a version of that couch model is needed with a polka-dot fabric instead of striped, using current techniques the couch must be reupholstered with the new fabric and new photography and 3D scanning must be taken. This is time-consuming and often cost-prohibitive.

This disclosure describes techniques to easily switch patterned images on a photorealistic texture map applied to an arbitrary 3D scanned mesh. It also allows the mesh itself to be scaled in a non-uniform manner. The polygonal mesh is separated into regions that correspond to areas of the object upon which a section of the surface material has been applied. For example, a polygonal mesh representing an upholstered couch would be separated into regions defined by the seams of the fabric. Regions for which the parameterization and texture image are to be changed are called non-static regions, which may be homeomorphic to a disk, while those meant to retain their original parameterization and associated pixels from their original texture images are called static regions. For each non-static region, a material pattern origin and orientation is defined. Then a UV mapping can be computed for the region, and a corresponding texture image created. The new texture image uses shading from the original texture map applied to a selected image tile that is scaled and repeated appropriately according to the real-world 2D size to which the image tile corresponds. The result is that photorealistic texture-mapped 3D models that are photographed can be changed to display any material pattern desired without physically changing the real-world object and acquiring additional photography and scanning.

A photorealistic effect can also still be achieved in cases where the model has been non-uniformly scaled to generate versions in different sizes before application of the techniques described herein. Since the surface is being re-parameterized, changes to the mesh structure made before re-parameterization will be taken into account automatically in the resulting mapping. Further, the shading brought over from the original texture image undergoes a face-by-face affine transformation regardless of whether any scaling takes place first, and the transformation takes such scaling into account.

It should be noted that in one example, it is recommended to capture an object with a solid color in the areas designated for texture modification so that differences in surface color other than shading do not impact the shading. A white color typically performs best to capture subtle shading, but gray and other neutral colors also work well. Depending on the type of effect desired, however, non-solid colors may still generate acceptable results. The image tiles used to establish the pattern of the new texture image have no color restrictions.

One example application of the techniques described herein is changing the fabric on 3D models of furniture. Upholstered furniture is typically offered in a variety of patterned fabrics, but capturing photorealistic 3D models of each fabric-to-frame combination is often time and cost prohibitive. In addition, manufacturers typically do not stock every fabric-to-frame combination, so they are not all available for photography, which is often necessary for a photorealistic result. The example techniques described herein can be used to switch the fabric pattern in the texture of the 3D model of a piece of upholstered furniture without photographing the new combination.

As described above, UV mapping governs with which set of pixels in an image file each face of a polygonal model is associated. In one example, UV mapping may be computed using an optimization-based method for parameterizing polygonal meshes while minimizing deformations. One basis for this approach is descripted in B. Levy. “Constrained Texture Mapping for Polygonal Meshes.” In Computer Graphics (SIGGRAPH Conf. Proc.). ACM, 2001 (hereinafter “Levy”), which is incorporated by reference herein in its entirety.

In Levy, constraints are set up in the form of linear equations that constrain the mapping φ(x, y, z)=[u v] of x, y, and z in R3 to u and v in UV space. The constraints match feature points between the model in R3 and the image through UV space, orient the gradient of the parameterization around the feature points, and ensure the regularity (variation in the gradient) of the parameterization across edges of the mesh. A roughness term, as described in J. L. Mallet. “Discrete smooth interpolation in geometric modeling.” ACM-Transactions on Graphics, 8(2):121-144, 1989 (herein after “Mallet”), which is incorporated by reference herein in its entirety, may be added to the system of equations, as described in Levy and B. Levy and J. L. Mallet. “Non-Distorted Texture Mapping for Sheared Triangulated Meshes.” In Computer Graphics (SIGGRAPH Conf. Proc.). ACM, July 1998, (hereinafter “Levy et al.”), which is incorporated by reference herein in its entirety, in order to also optimize for smoothness in the resulting parameterization. The constraints may at times work against each other, so the contribution of each constraint in the system of equations can be multiplied by a coefficient to weight it according to its importance to the application (in one example, all constraints are normalized and then the coefficient applied to the regularization constraint is set to 20 times that of the other constraints). A conjugate gradient method may then be used to find a least squares optimal solution to the system of equations.

Levy includes the following types of constraints in the described system of equations: feature point matching, gradients at feature points, and regularization of variation in the gradient across shared edges. The feature point matching and gradients at feature points constraints are related to the establishment of control points. In Levy, each control point has a position in R3, a position in UV space, a vector in R3 that directs the gradient in the U direction in UV space (G_{U}), and a gradient in R3 that directs the gradient in the V direction in UV space (G_{V}). The constraint that matches feature points sets the location in R3 to the location in UV space (it is technically the locations of the vertices of the containing polygon that are constrained according to the point's barycentric coordinates in the R3 and UV spaces). The gradient constraints set the magnitude and direction of the gradient of the parameterization φ(x, y, z) at control points according to the respective gradient vectors in R3. The regularization constraints are defined on all shared edges of the polygonal mesh and serve as an extrapolator for the control point constraints that ensure the homogeneity of the solution (e.g. similar regions of a mapped image appear to be the same size on one area of the mesh surface as another). The regularization constraints set the variation of the gradient of the parameterization (approximating the directional second derivatives of the parameterization, which are not defined for a piecewise linear parameterization) on one side of a shared polygonal edge equal to its counterpart on the other side of the edge. It should be noted that a control point data structure may have one or more of the following key members: Position in R3, Containing face and barycentric coordinates, Position in UV space, R3 vector for UV gradient in the U direction (G_{U}), and R3 vector for UV gradient in the V direction (G_{V}).

As described in detail below, there are at least two key differences in the parameterization of the mesh between the techniques described herein and that of Levy. The first is that, in the techniques described herein, surface and image features are used to establish only the first control point, while all others are established using a different process. The second is that the texture image against which the mesh is being parameterized displays a pattern that must be scaled and tiled appropriately to match the parameterization rather than left static.

As described above, in the example techniques described herein surface and image features are not used to create any but the first control point. Control points in Levy are established to link features on the mesh surface in R3 to features of the image in UV space, stretching the image to meet those requirements. Operation of the process for Levy involves a user selecting a feature point on the surface of the mesh in R3 and selecting a corresponding feature point in the image in UV space and linking the two by the establishment of a control point. The user then sets the direction and magnitude of the G_{U} and G_{V} vectors at the site of the control point in R3. For example, to parameterize the model of a face for application of a texture image of a face, the user could create control points at the locations of the eyes, nose, and mouth in both R3 and UV space to pin those areas of the image to the corresponding locations on the model, and direct the gradients so the image flows correctly around them.

In one example, according to the techniques described herein, however, an image tile is to be repeated across the surface of the mesh as a pattern. For example, a virtual model of a couch in a green striped fabric pattern can be changed to exhibit a red polka dot fabric pattern while retaining the realism afforded by a 3D scan combined with image-stitched photography for the texture image. Thus, in re-parameterizing a mesh for a pattern, however, only a single feature point is relevant: the starting position. The user may define a control point for the starting point of the pattern (the “basis control point”), which is a point in R3 on the surface of the mesh that corresponds to a position on the image tile from which to repeat, taken in one example to be the origin (0, 0) of the image tile. The user may also define an orientation for the pattern to be applied to the surface at the control point, which comprises the G_{U} and G_{V} vectors. From there, however, the desire is to essentially “roll” the repeated pattern across the surface of the mesh, repeating the image at an appropriate scale and retaining an orientation in line with the G_{U} and G_{V} vectors of the starting control point along isoparametric curves.

It should be noted that in some cases, additional correspondences between the mesh surface in R3 and the image tile cannot be set manually by a user. That is, the tile is repeated across the surface at a constant size from the basis control point, and a user will not be able to judge visually how the repeated image features will match up with the surface geometry before performing the parameterization since there are no other visual feature correspondences. Yet defining a single control point is not sufficient for generating an appropriate parameterization using the process in Levy unless the surface is completely flat or the parameterization of the border vertices is known, neither of which can be expected. When applied without additional control points and not under those conditions, the parameterization will look appropriate only in the region immediately surrounding the single control point. Other areas of the parameterization will be warped and misplaced, resulting in a poor visual result for the texture map. Instead, in some cases, control points must be established at key points across the surface of the mesh to ensure a visually appropriate parameterization everywhere. Since the user is unable to manually identify additional control points or even how many will be necessary and where on the mesh, a different approach must be taken that does not rely on feature points other than the starting position for the basis control point.

As described in detail below, the example techniques described herein may create an isoparametric grid of control points across the surface of the mesh in R3. It should be noted that by creating control points that lie on isoparametric curves that make up a grid, the UV positions of each control point can be calculated using the distance along a single dimension from another control point on the same isoparametric curve. To determine that distance, the example techniques described herein may define a relationship between units in R3 and units in UV space.

In one example, d can be equal to the distance in UV space that corresponds to 1 unit in R3. For simplicity, d may be equal to 1 so that 1 unit in UV space equals 1 unit in R3. Also for simplicity, it may be assumed that 1 unit in R3 in a virtual representation represents 1 meter in the real-world. With these relationships in mind, the UV distance along an isoparametric curve is related to the geodesic distance between the two positions in R3 along the surface of the mesh. If, as in this example, the relationship is 1:1, the UV distance is equal to the geodesic distance. By constraining movement along an isoparametric curve, UV space is changing in only one dimension at a time, so the distance traveled in UV space can be used to set the change in UV position. Therefore, by moving along isoparametric curves beginning at the basis control point, the geodesic distance traveled can be used to translate the current R3 location to the appropriate corresponding location in UV space.

In one example, the parameterization gradient vectors G_{U} and G_{V} in the U and V directions, respectively, for each control point are projected onto the plane of the control point's containing face in such a way that it preserves the original gradient of the basis control point in its key direction by always remaining orthogonal to the other gradient vector (e.g. G_{U} remains orthogonal to G_{V} in all cases). The process is described in further detail below. The result is that the image tile is repeated in a consistent orientation and at a consistent scale to create the effect of a repeated tile across the surface. Taking the previous example of a couch, the polka dot pattern is repeated as if a fabric is rolled out across a surface, and therefore cannot change directions without bunching up the flat fabric, which is undesirable. Furthermore, its scale remains consistent since the pattern would be printed on a fabric at a constant size.

It should be noted that in Levy et al. the authors suggest using four isoparametric curves as extrapolators for the parameterization when borders are irregular and their parameterization is not a priori known. This approach, however, differs from the techniques described herein and is not sufficient to achieve the desired result for two reasons. The first reason the approach in Levy et al. is not sufficient is that using four isoparametric curves as Levy et al. suggests results in reasonable parameterization only in the area between the curves, while all other areas for most mesh surface shapes suffer from UV warping and misplaced UV coordinates. Especially since polygonal mesh geometries are not necessarily quadrilateral in surface shape, there are often large swaths of surface area that cannot be contained in any positioning of four isoparametric curves. The second reason the approach in Levy et al. is not sufficient is that the position in UV for each point on the isoparametric curve is known only in one dimension; the distance along the curve is unknown and does not figure into the calculation for a parameterization solution. Without constraining both dimensions of the parameterization in UV space at each isoparametric curve point location, the resulting parameterization suffers from additional warping. The techniques described herein may instead establish control points in along a grid of isoparametric curves, recording the desired UV space locations for each grid intersection point. The creation of this grid is described in detail below and differs from the simple manual user definition of the four isoparametric curves in Levy et al.

As described above, the techniques described herein may differ from current techniques in that the texture image against which the mesh is being parameterized displays a pattern that must be scaled and tiled appropriately to match the parameterization to create a realistic effect, rather than left static. Further, the parameterization may result in mappings to UV locations that are outside the bounds of the original image tile since it is expected to be repeated continuously across the mesh surface. Further, the image may not be able to be simply tiled as is; the scale is important so that the image repeats are sized appropriately. Taking the previous virtual couch example, polka dots in the image that are 10 pixels wide might correspond to dots that are 5 cm in diameter on a real-world fabric, and this difference must be accounted for. An example technique for scaling and repeating the image tile is described in detail below.

As described in detail a below, in one example, the texture image for each mesh region may be constructed by compositing two intermediate images: (1) An unshaded version patterned per the new parameterization with the new image tile, and (2) An image that displays shading from the model's original texture map, rearranged to accommodate the new parameterization for the region. In one example, to create the unshaded image, the image tile is first resealed. The smaller of its two dimensions in image space is scaled to correspond to one unit in the associated dimension of UV space (U for width and V for height). The aspect ratio of the image tile may be maintained during scaling by setting the larger dimension using the new size of the smaller dimension and the original aspect ratio of the smaller to the larger. The image tile may be positioned in the unshaded image so that its origin in image space corresponds to the origin in UV space of the new parameterization. Since UV locations outside of the range [0, 1) correspond to repeats of the image tile, the process repeats the image tile vertically and horizontally an integer number of times to ensure all image space locations that correspond to UV locations of vertices in the new parameterization lie on a pixel of the unshaded image.

In one example, to construct the shading image, the shading of each face in the mesh region is copied from the original texture image into the shading image. To do so, the original texture image is converted into HSV color space and the V channel, which displays brightness, is separated out. Then for each face, a transformation is performed on the related pixels in the V channel of the original texture image and the result is copied into the new shading image. The transformation matrix is determined by computing the transformation of the UV locations of the original parameterization for the face to the UV locations for the new parameterization of the face. In this way, the shading is copied face by face into a new image that has placement corresponding to the new parameterization for the mesh region.

Once the unshaded and shaded texture images have been computed, they are composited by multiplicatively applying the shading image value (as a fraction of full brightness) for each pixel to the V channel of the unshaded image in the same pixel in HSV space. Once complete, the results are converted back to the RGB color space.

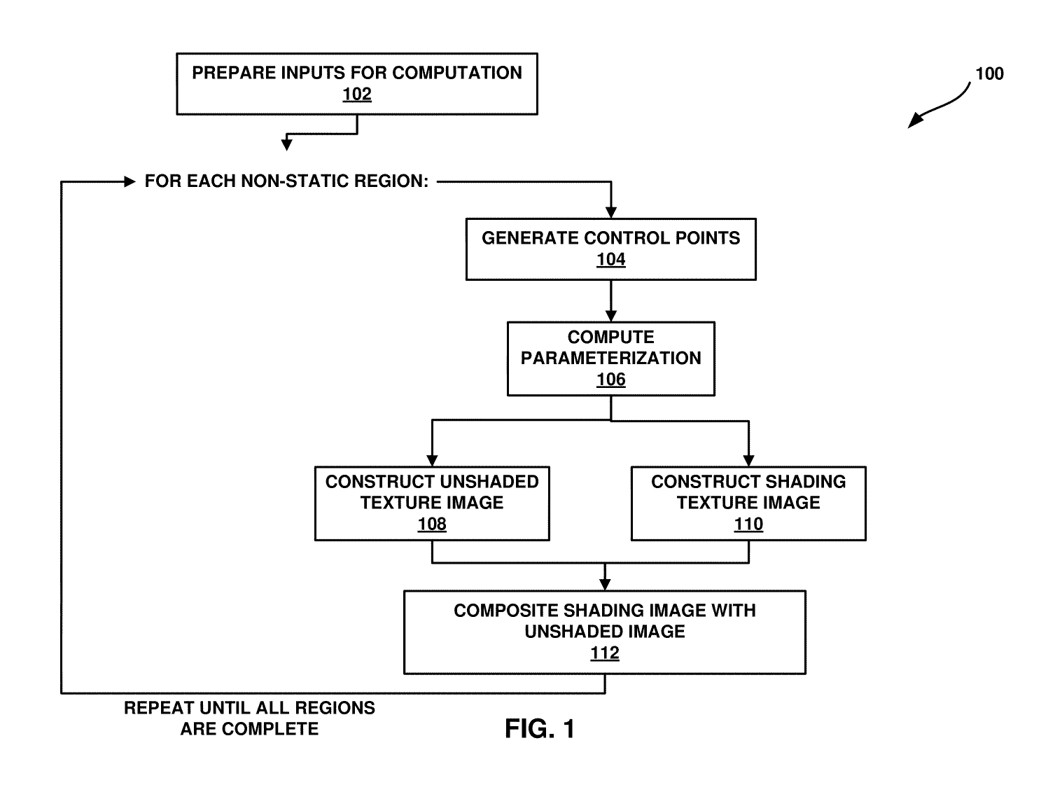

As described above, the techniques described herein may be used to change the surface texture of a target virtual object. FIG. 1 is a flow diagram depicting an example process of changing the surface texture of a target virtual object according to the example techniques described herein. It should be noted that a computing system, for example, computing system 1200, may be configured to perform one or more steps of process 100. Further, a computing system may be configured to enable a user to perform one or more of the steps of process 100 (e.g., by providing a graphical user interface enabling a user to perform a step).

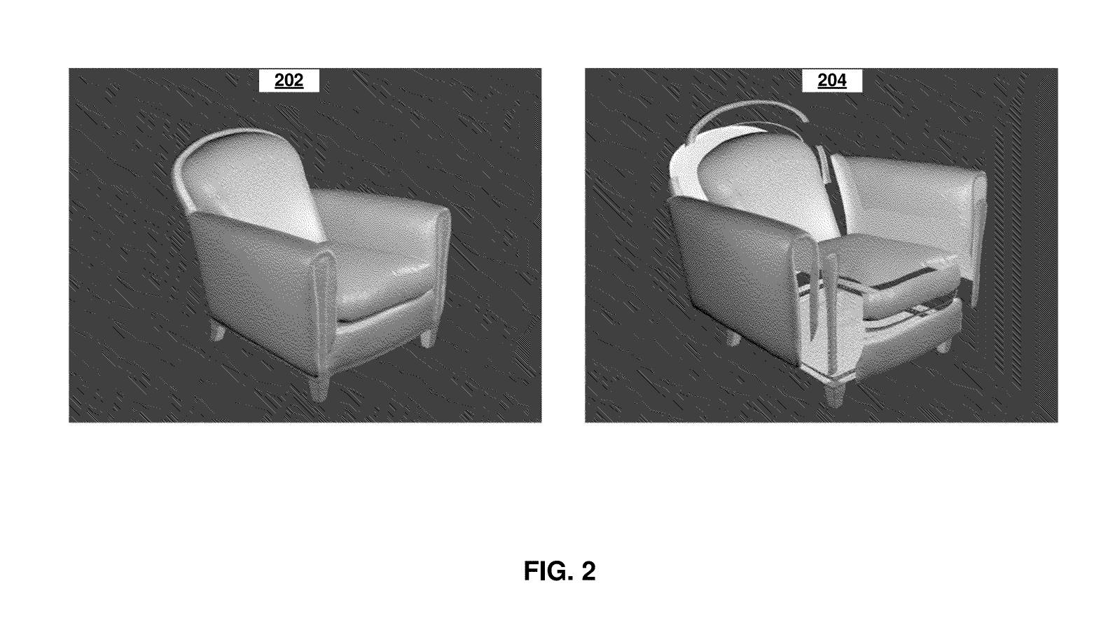

As illustrated in FIG. 1, process 100 begins at 102, where inputs are prepared for computation. In one example, inputs may be prepared for computation through the following actions (1) Alter the captured 3D virtual model by scaling if desired; (2) Separate the virtual model into regions that are either homeomorphic to a disk (“non-static regions”) or are meant to retain their original parameterization and their portion of the original texture image (“static regions”); (3) Let d equal the distance in UV space that corresponds to 1 unit in R3. As described above, for simplicity, d=1 so that 1 unit in UV space equals 1 unit in R3; (4) For each non-static region, create and position a parametric basis in R3. The parametric basis consists of an origin point (P_{B}), a vector in the U direction, G_{U}, and a vector in the V direction, G_{V}. The parametric basis defines the starting point and orientation of the texture tiling to be created. (5) Select an image tile Tₜ to be used for the new surface pattern for the model. Let it have a 2D pixel size of pₓ pixels in width by p_{y} pixels in height, and let it correspond to a flat R3 area of size mₓ meters by m_{y} meters, respectively. (6) Select a desired size for the output texture image in pixels of t_{w} pixels wide by tₕ pixels high. In one example, a user may manually prepare the inputs for computation with the assistance of a computing device. FIG. 2 illustrates an example of a 3D model. In the example illustrated in FIG. 2, an example un-textured mesh before modification and an exploded view of the un-textured mesh after being separated into regions.

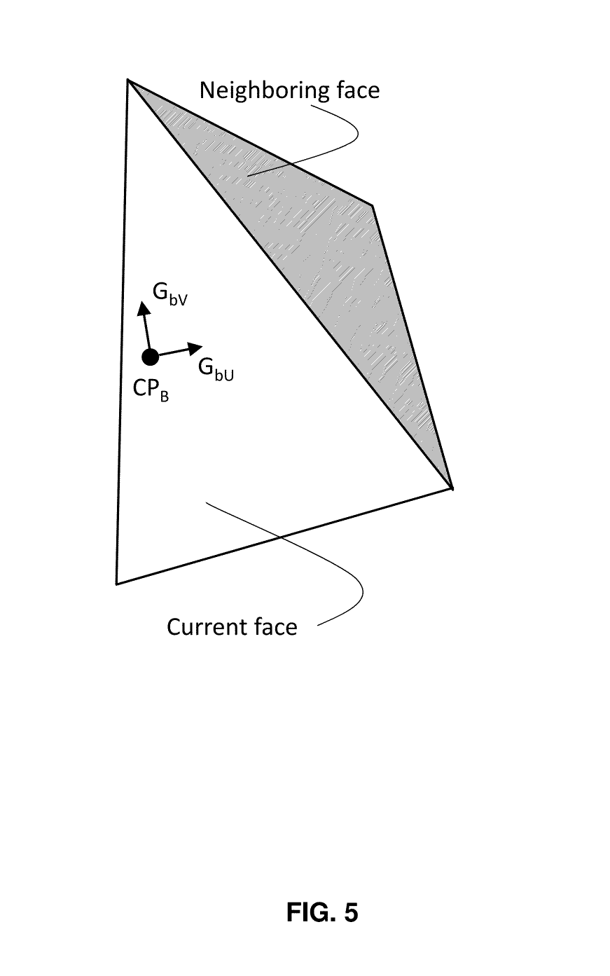

Referring again to FIG. 1, after inputs are prepared for computation, at 104, control points may be generated for each non-static region. In one example, control points may be generated by (1) creating a basis control point, and (2) creating additional control points based on the basis control point. In some examples it may be desirable that additional control points are present in as many faces of the mesh as possible. In one example, creating a basis control point may include creating a basis control point that corresponds to the origin in UV space, where, in one example, the R3 position of the control point is given by the R3 position of P_{B}, the UV position of P_{B} is taken to be (0.0, 0.0), and the gradients in the U and V direction are given by G_{U} and G_{V}, respectively. FIG. 5 is a conceptual diagram depicting a basis control point, CP_{B}, on the surface of a region of a mesh region with two faces. In the example illustrated in FIG. 5, the basis control point's gradient in the U direction is displayed as G_{bU}, and its gradient in the V direction is displayed as G_{bV}. Both gradients lie in the plane of the face that contains the basis control point.

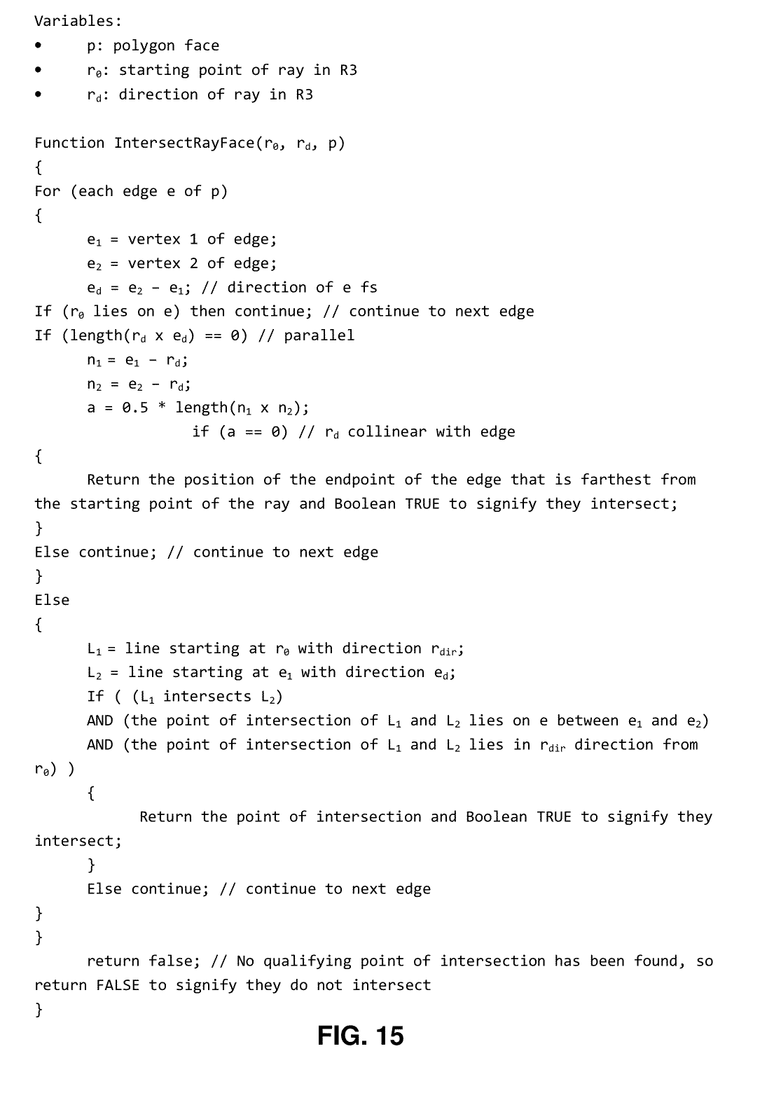

Starting at the basis control point, in one example, additional control points may created at points on edges of the mesh in R3 that lie along isoparametric curves in the positive and negative U directions, as well as the positive and negative V directions in UV space. If a face already contains a control point, progress along that direction is terminated. Each new point itself then serves as a starting point to continue forward and backward in both U and V, creating additional points. This process may be repeated with the new control points created until no new control points remain pending at the end of an iteration. An example of pseudo-code for the traversal is illustrated in FIG. 14.

Given a starting control point, several steps may be taken to traverse in each direction in {G_{U}, −G_{U}, G_{V}, −G_{V}} for the control point:

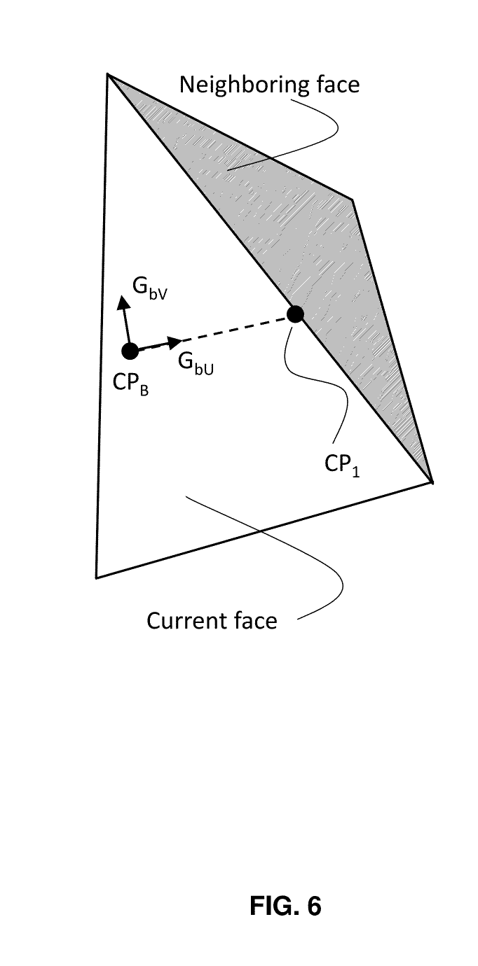

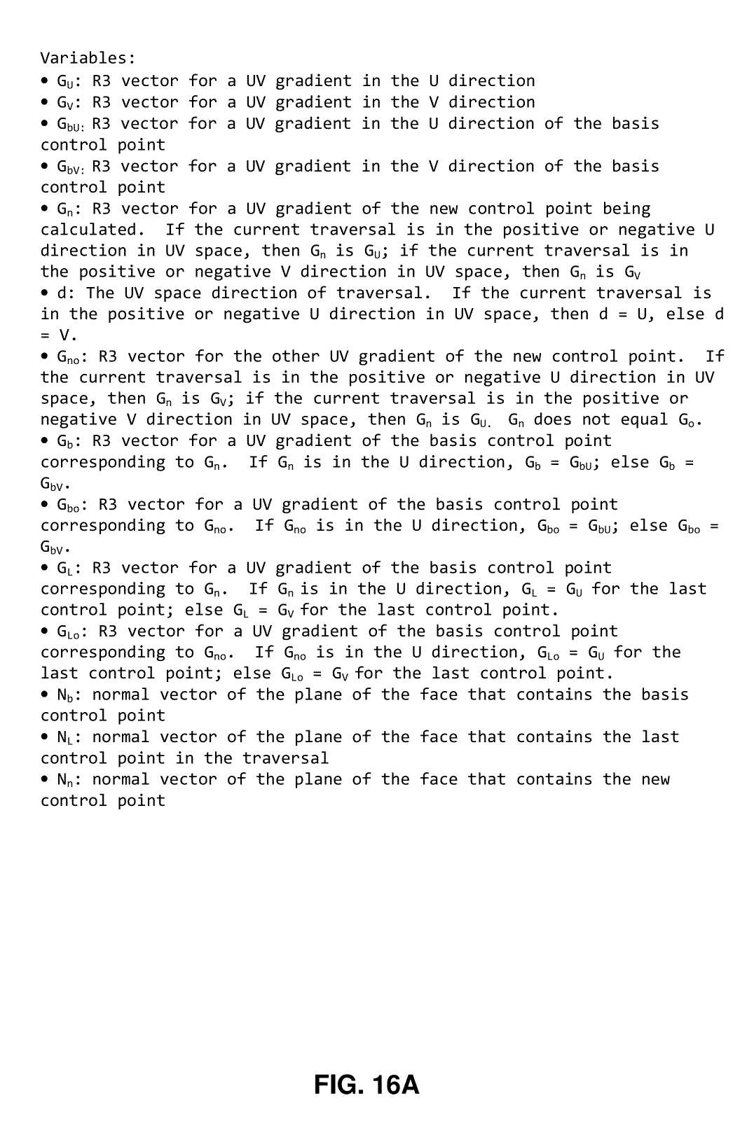

1. A ray is cast from the R3 position of the current control point in the current direction of traversal. A computation is performed to determine whether and where this ray intersects an edge of the face that contains the current control point, as described in pseudo-code illustrated in FIG. 15 and depicted in FIG. 6.
a. If the ray does not intersect the containing face but the current control point lies on an edge or at a vertex of the face, faces that share the edge or vertex are tested as follows:
   i. Create a copy of the control point and then switch the copy's recorded containing face and barycentric coordinates, then update its gradient vectors as described in section 2.a below.
   ii. Determine whether and where the control point intersects an edge of its containing face.
   iii. Delete the control point copy.
   iv. If the ray has intersected an edge of the control point's current containing face, create a new control point at the location of the intersection and discontinue checking the other faces that share last control point's incident edge or vertex.
b. If the ray is not found to intersect any face on which the control point is incident, the current traversal path is terminated at the current control point.

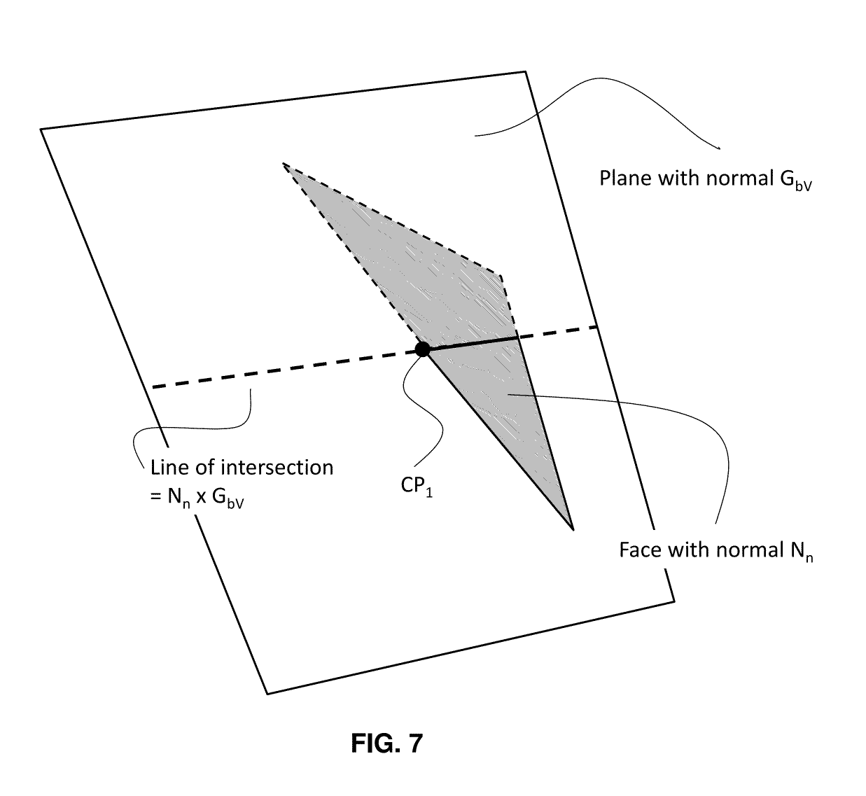

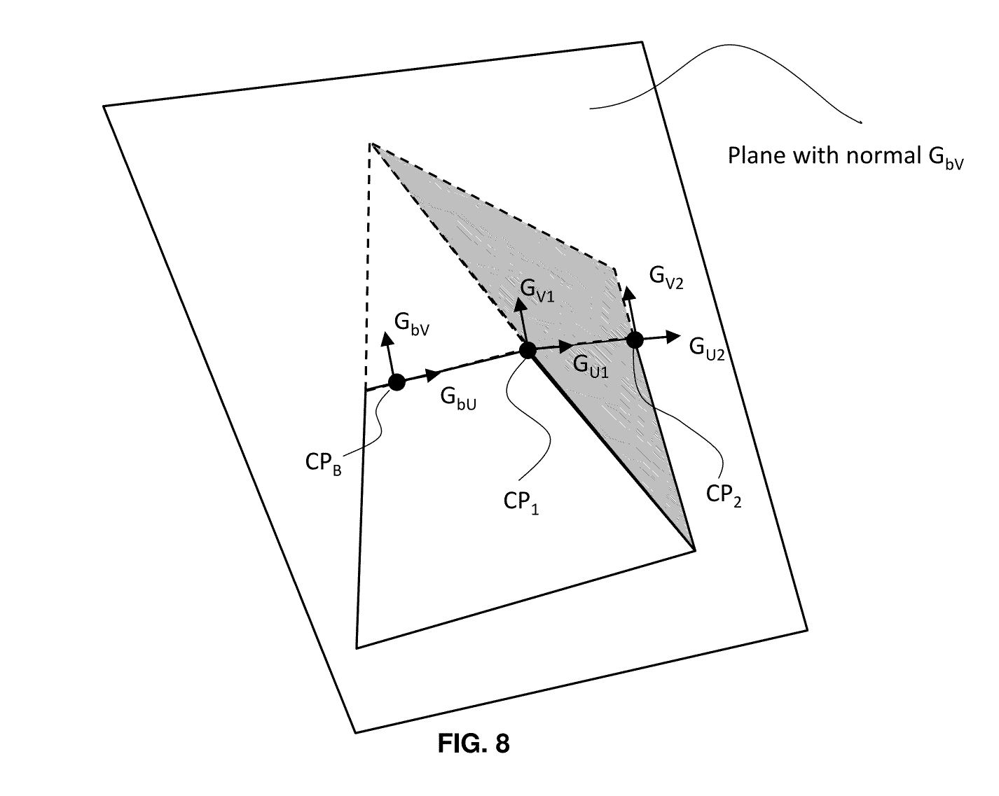

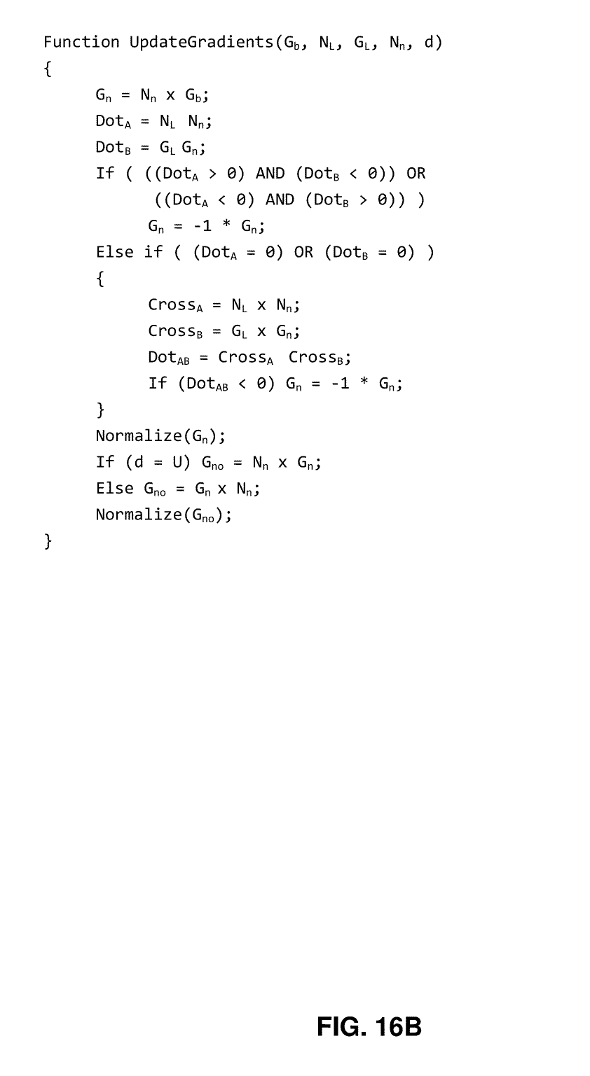

2. If a new control point has been created:
a. Assign values to the new control point.
   i. The point of intersection becomes the R3 position of a new control point.
   ii. If the direction of traversal is in {G_{U}, −G_{U}}, the V coordinate in UV space of the new control point is assigned to the same value as for the last control point in the traversal. Similarly, if the direction of traversal is in {G_{V}, −G_{V}}, the U coordinate in UV space of the new control point is assigned to the same value as for the last control point.
   iii. If the direction of traversal is in {G_{U}, −G_{U}}, the U coordinate in UV space of the new control point is assigned to the U coordinate value of the last control point in the traversal plus the R3 distance from the last control point to the new control point (since the traversal between the two has been planar in the shared containing face, so the R3 distance equals the geodesic distance in this case). Similarly, if the direction of traversal is in {G_{V}, −G_{V}}, the V coordinate in UV space of the new control point is assigned to the V coordinate of the last control point plus the R3 distance from the last control point to the new control point in R3.
   iv. G_{U} and G_{V} for the new control point are initially set to the same value as for the last control point in the traversal, and then are updated when its containing face is updated in section 2.b below.
b. Since R3 lies on an edge, determine whether that edge is shared with another face. If not, delete the new control point and terminate the current traversal path because there are no further faces in the current direction of traversal to explore (the end of the mesh has been reached); if, however, the edge is shared (the end of the mesh has not yet been reached), switch the face designated as the containing face of the new control point and update its gradient vectors G_{U} and G_{V} as follows, where Gₙ is either G_{U} or G_{V} depending on the direction of traversal, while Gₙₒ is the other of the two. G_{b} is the basis control point vector corresponding to Gₙ, while G_{bo} is the basis control point gradient vector corresponding to Gₙₒ. Variable name definitions and pseudo-code for updating gradients are illustrated in FIGS. 16A-16B. The process follows:
   i. Restrict Gₙ to lie in the plane defined with G_{bo} (e.g. if traversing in the G_{U} or −G_{U} directions, G_{U} for each new control point must be orthogonal to the basis control point's gradient G_{bV}; alternatively, if traversing in the G_{V} or −G_{V} directions, G_{V} for each new control point must be orthogonal to the basis control point's gradient G_{bU}). This restriction is designed to ensure traversal remains along an isoparametric curve across the surface of the region. Also restrict Gₙ to lie in the plane of the face containing the control point since gradient vector constraints to be created must lie on the surface of the mesh. Therefore, calculate Gₙ as lying along the line where the planes defined by normals Nₙ and G_{bo} intersect, as depicted in FIG. 7. This intersecting line can be found using the cross product. In the example illustrated in FIG. 7, the line of intersection is in the U direction between the plane of the face containing the control point C_{P1} and the plane with normal G_{bV} (the gradient in the V direction for the basis control point, which is orthogonal to the current direction of traversal). Dotted lines depict geometry behind the plane with normal G_{bV} with respect to the viewing angle;
   ii. Determine the direction of Gₙ along the intersecting line. Gₙ should travel along the surface of the mesh in a consistent direction from G_{b}, as given by:
      1. The dot product of N_{L} and Nₙ should have the same sign as the dot product of G_{L} and Gₙ. If they do not, reverse the direction of Gₙ.
      2. If either of the dot products are zero, the results of the following cross products should point in the same general direction: N_{L}×Nₙ and G_{L}×Gₙ. If they do not, reverse the direction of Gₙ.
   iii. Normalize G.
   iv. Set Gₙₒ to be orthogonal to Gₙ and in the plane of the face that contains the control point.
   v. Normalize Gₙₒ
   c. Save the control point identifier in a pending list to be traversed in the parametric directions orthogonal to the current one. For example, if current traversal is in either the G_{U} or −G_{U} directions, the control point identifier should be added to the pending list L_{V} for a pending traversal starting at the control point in both the G_{V} and −G_{V} directions; alternatively, if current traversal is in either the G_{V} or −G_{V} directions, the control point identifier should be added to the pending list L_{U} for a pending traversal starting at the control point in both the G_{U} and −G_{U} directions.
   d. If the end of the mesh has not yet been met, continue traversing along the same path by repeating the process starting with step 1. FIG. 8 illustrates a two-face mesh region with two control points added along the positive U direction traversal from the basis control point. In the example illustrated in FIG. 8, traversing a face in R3 along an isoparametric curve in the U direction, orthogonal to the plane with normal G_{bV} (the gradient in the V direction for the basis control point, which is orthogonal to the current direction of traversal), from the basis control point CP_{B} to a new control point C_{P1} on the edge of the current face, then to another new control point C_{P2} on a neighboring face is illustrated. Dotted lines depict geometry behind the plane with normal G_{bV} with respect to the viewing angle. If, however, traversal has completed, repeat the process starting with step 1 for the next control point in the current pending list L_{U} or L_{V} in the positive and negative directions of the associated vector. If the current pending list has been exhausted, erase all elements within it and move to the other pending list. If both pending lists have been exhausted, the grid is complete; move on to the next step.

Referring again to FIG. 1, after a control points are generated, at 106, the parameterizations may be computed. Computing parameterizations may include building a set of linear equations, adding roughness to the linear equations, and finding a least-squares solution to the set of linear equations. In one example, using the control points created as described above, a set of linear equations may be created using techniques described in Levy. Further, in one example, a conjugate gradient method may be used to find a solution to the set of linear equations.

In one example, adding roughness to the set of linear equations may include using the definition from Mallet and the discrete smooth interpolation (DSI) equation from Levy and may include:

Optimization from Levy: Minimize the norm of the residual ∥G·x+c∥

DSI from Mallet: W_{II}·φ_{I}=ψ_{I} where ψ_{I}=−W_{IL}·φ_{L}

Adding DSI to the optimization from Levy, minimize the norm:

∥(G+W_{II})·x+(x+ψ_{I})∥,

Referring again to FIG. 1, after parameterizations are computed, at 108, unshaded texture images are constructed, and, at 110 a shading texture images are constructed. It should be noted that the order in which unshaded texture images are constructed and shading texture images are constructed may be interchanged.

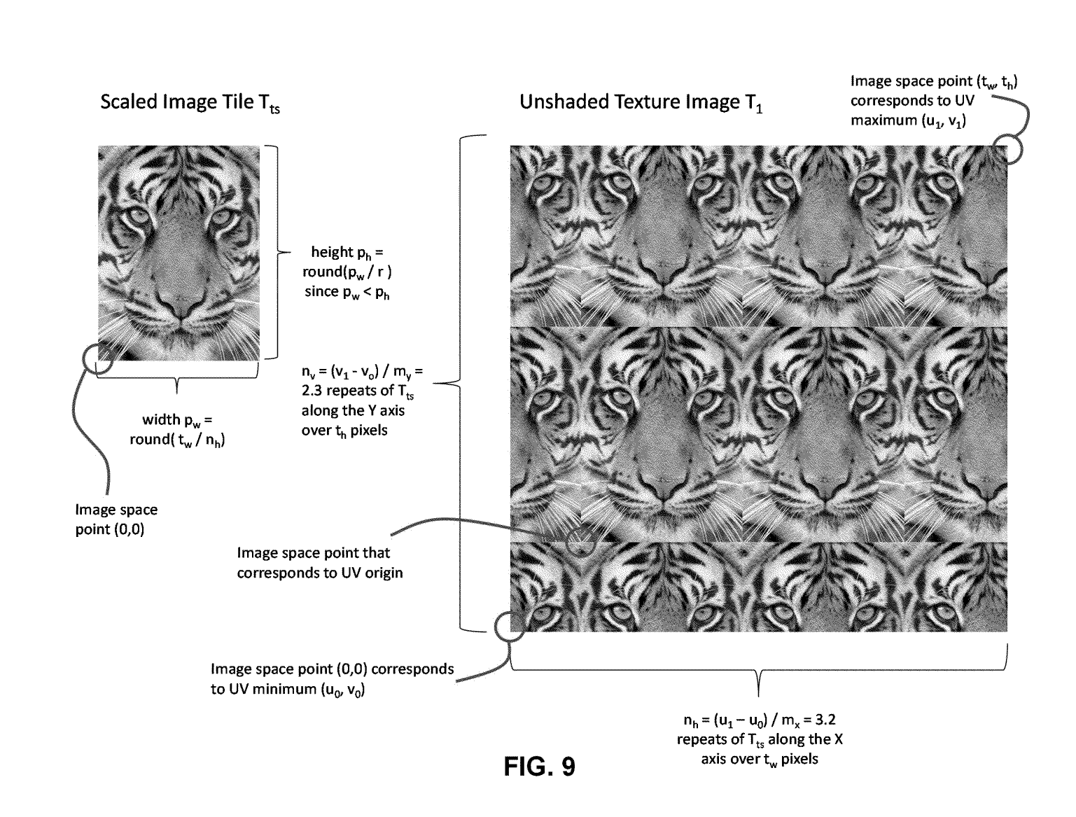

In one example, for each non-static region, an unshaded texture image T₁ may be created to be combined with an associated shading image T₃. An example construction of a shading image is described in detail below. The result of combining an unshaded texture image with an associated shading image is a final texture image for a region. This result is described in further detail below. In one example, a texture image must correspond to the parameterization determined as described above. An example of a scaled image tile Tₜₛ (defined below) and an unshaded texture image T₁ are illustrated in FIG. 9.

In one example, a unshaded texture image may be created as follows:
1. Compute the bounding box of values in UV space for a parameterization, where a parameterization may include one of the parameterizations described above. In one example, the minimum point of the bounding box is (u₀, v₀) and the maximum point of the bounding box is (u₁, v₁).
2. Find the following values (using, for example, inputs described above):
   Desired number of horizontal repeats of the image tile in texture image: nₕ=(u₁−u₀)/mₓ
   Desired number of vertical repeats of the image tile in texture image: nᵥ=(v₁−v₀)/m_{y}
   Desired width of tile in pixels: p_{w}=round(t_{w}/nₕ)
   Desired height of tile in pixels: pₕ=round(tₕ/nᵥ)
   Ratio of width to height in the image tile: r=pₓ/p_{y}
3. The resulting p_{w} and pₕ values may not be in the same aspect ratio as the image tile, which could lead to stretching in one dimension if the image tile is scaled according to these values. To avoid stretching, set the size using the smaller of p_{w} and pₕ, and then compute the size of the other dimension using the ratio of the dimensions of the image, as in:

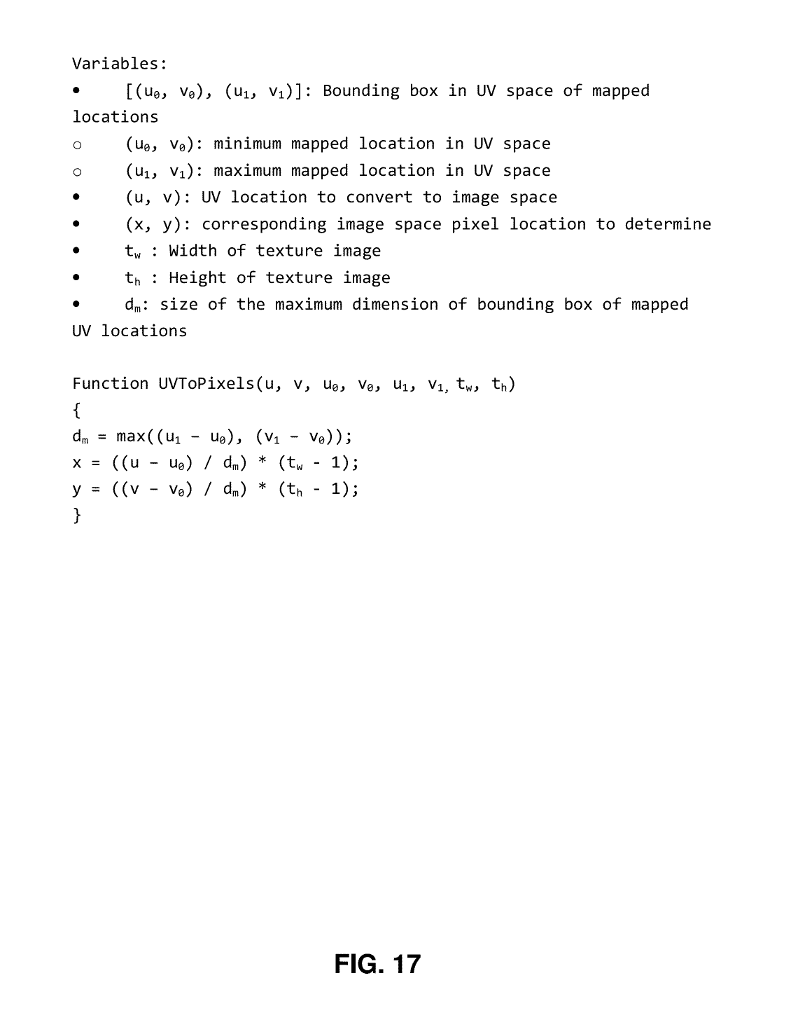

If (p_{w}<pₕ) pₕ=round(p_{w}/r); else p_{w}=round(pₕ*r)
4. Create a scaled version Tₜₛ of the image tile Tₜ that is p_{w} pixels in width and pₕ pixels in height.
5. Find the pixel location (x₀, y₀) in image space that corresponds to the origin in UV space (0, 0). An example of finding the pixel location is detailed in the pseudo-code illustrated in FIG. 17.
6. Create new blank image T₁ of width (p_{w}*nₕ) and height (pₕ*nᵥ).
7. Repeatedly copy the scaled image tile Tₜₛ into T₁ starting at from (x₀, y₀) in image space in T₁ and moving outward in both the positive and negative directions of the X and Y axes, cropping the result to bounds of the texture image. An example of this is illustrated in FIG. 9. The result, once composited with the shading image, will form a texture map image.

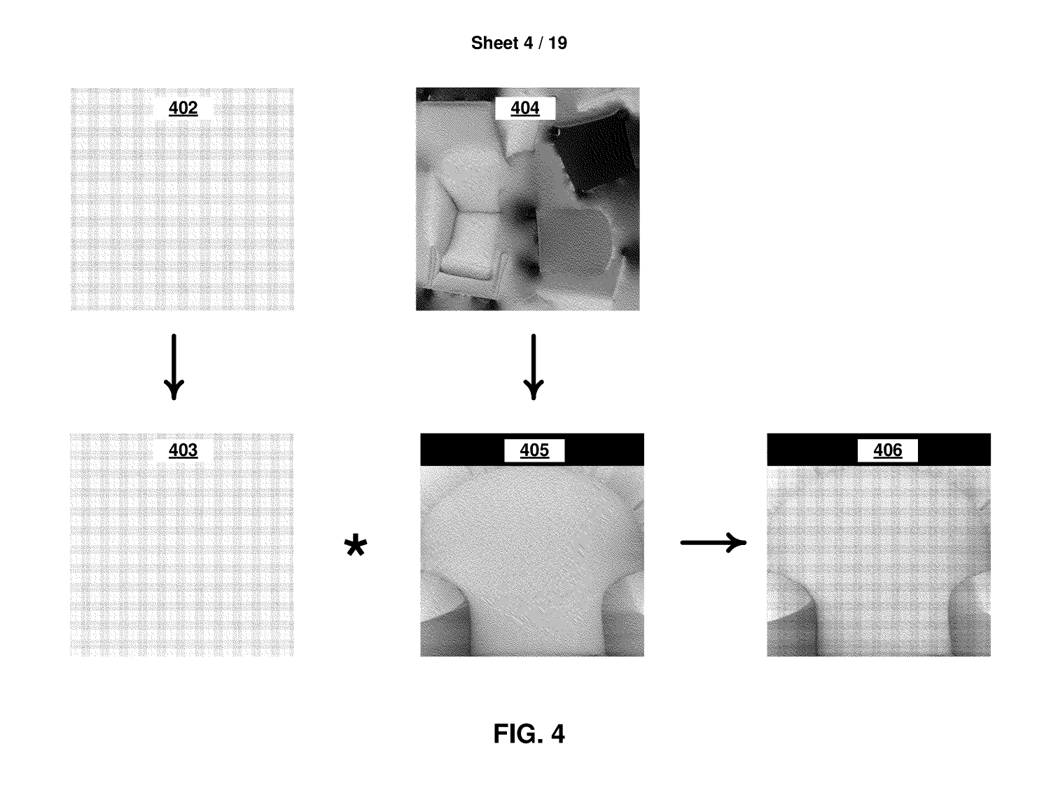

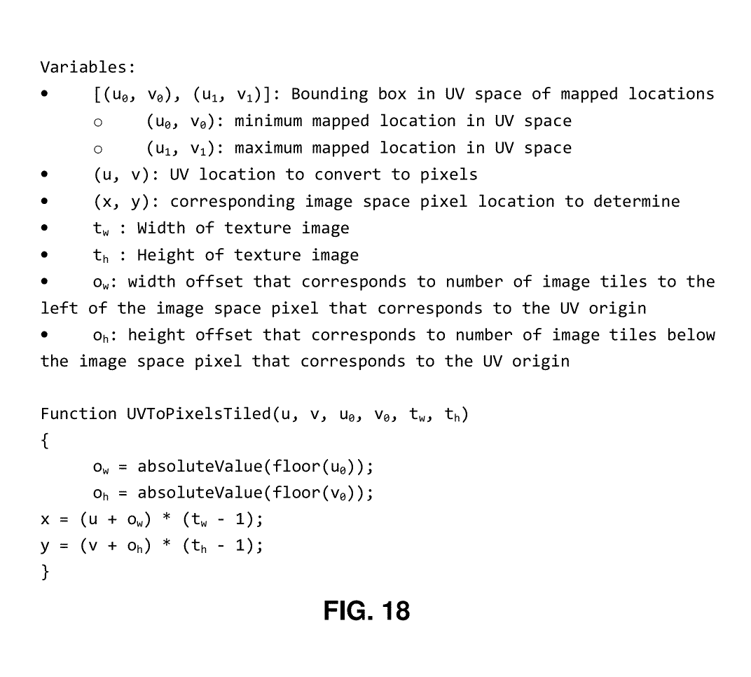

In one example, to construct a shading texture image for each non-static region, create a single-channel grayscale texture map image to be used to apply shading to the tiled texture images. In one example, the shading image must correspond to the parameterization determined above. An example of an untextured shading image is illustrated in FIG. 4. The following images are included in the example of FIG. 4, an example tile to be patterned across the mesh surface 402, the original texture image 404, the tiled, unshaded image 403, the scaled shading image T₂ₛ 405; and the final texture image T₃ 406. In one example, creating a single-channel grayscale texture map image may include the following:
1. Find the bounding box in UV space of the new parameterization φ₁. In one example the bounding box may include the bounding box computed above, where B₁₁₀₀ =[(u₀, v₀), (u₁, v₁)].
2. Create a blank new image T₂. The size of T₂ may be set as a multiple in image space in each of the X and Y directions of the original texture image T₀ size, which have width w₀ and height ho in pixels. Therefore, the width of the image may be an integer multiple r_{X} of w₀ and the height may be an integer multiple r_{Y} of h₀. The size determined as follows:
   a. The multiples r_{X} and r_{Y} satisfy the following conditions:
      i. All UV space values of the parameterization φ₁ are represented in the new image;
      ii. Each tile has UV space dimensions one unit in U by one unit in V;
      iii. The UV location (0, 0) is mapped to an image space location that contains the value at pixel (0, 0) in the original texture image T₀; and
      iv. r_{X} and r_{Y} are integers.
   b. Determine multiples r_{X} and r_{Y} to satisfy the conditions of step 2.a:
      i. Repeats in negative X from pixel (0, 0): r_{L}=floor(u₀)
      ii. Repeats in negative Y from pixel (0, 0): r_{D}=floor(v₀)
      iii. Repeats in positive X from pixel (0, 0): r_{R}=ceiling(u₁)
      iv. Repeats in positive Y from pixel (0, 0): r_{U}=ceiling (v₁)
      v. Total repeats along X axis: r_{X}=abs(r_{L})+abs(r_{R})
      vi. Total repeats along Y axis: r_{Y}=abs(r_{D})+abs(r_{U})
   c. The size of T₂ is computed as follows for width w₁ and height h₁ in pixels:
      i. w₁=w₀*r_{X}
      ii. h₁=h₀*r_{Y}
3. For each face f in the mesh region:
   a. For each vertex i:
      i. Look up the original UV mapping φ₀ᵢ for the vertex.
      ii. Look up the new UV mapping φ₁ᵢ for the vertex, which may be computed as described above.
   b. Compute the centroid of the original UV mapping φ_{0c} for the face by averaging those of its vertices.
   c. Compute the centroid of the new UV mapping φ_{1c} for the face by averaging those of its vertices.
   d. For each sub-triangle of the face f, made up of the centroid, c, and two adjacent vertices of the face, i and j:
      i. φ_{0c}, φ₀ᵢ, φ₀ⱼ represents the original UV mapping for the sub-triangle
      ii. φ_{1c}, φ1i, φ₁ⱼ represents the new UV mapping for the sub-triangle
      iii. Convert the UV space locations of φ_{0c}, φ₀ᵢ, φ₀ⱼ to image space locations p_{0c}, p₀ᵢ, p₀ⱼ in the original texture image T₀ using the process detailed in pseudo-code illustrated in FIG. 17 and let:
         1. p_{0c}=(x_{0c}, y_{0c})
         2. p₀ᵢ=(x₀ᵢ, y₀ᵢ)
         3. p₀ⱼ=(x₀ⱼ, y₀ⱼ)
      iv. Convert the UV space locations of φ_{1c}, φ₁ᵢ, φ₁ⱼ to image space locations p_{1c}, p₁ᵢ, p₁ⱼ in the new shading image T₂ using the process detailed in pseudo-code illustrated in FIG. 18 and let:
         1. p_{1c}=(x_{1c}, y_{1c})
         2. p₁ᵢ=(x₁ᵢ, y₁ᵢ)
         3. p₁ⱼ=(x₁ⱼ, y₁ⱼ)
      v. Find the image space bounding box B₀=[(x₀₀, y_{(0,0), (x}₀₁, y₀₁)] of p_{0c}, p₀ᵢ, p₀ⱼ
      vi. Find the image space bounding box B₁=[(x₁₀, y₁₀), (x₁₁, y₁₁)] of p_{1c}, p₁ᵢ, p₁ⱼ
      vii. Find new the image space locations by translating those of the original mapping p_{0c}, p₀ᵢ, p₀ⱼ of the face and those of the new mapping p_{1c}, p₁ᵢ, p₁ⱼ of the face to be relative to the origins of their bounding boxes, B₀ and B₁, respectively:
         1. p_{2c}: x_{2c}=x_{0c}−x₀₀; y_{2c}=y_{0c}−y₀₀
         2. p₂ᵢ: x₂ᵢ=x₀ᵢ−x₀₀; y₂ᵢ=y₀ᵢ−y₀₀
         3. p₂ⱼ: x₂ⱼ=x₀ⱼ−x₀₀; y₂ⱼ=y₀ⱼ−y₀₀
         4. p_{3c}: x_{3c}=x_{1c}−x₁₀; y_{3c}=y_{1c}−y₁₀
         5. p₃ᵢ: x₃ᵢ=x₁ᵢ−x₁₀; y₃ᵢ=y₁ᵢ−y₁₀
         6. p₃ⱼ: x₃ⱼ=x₁ⱼ−x₁₀; y₃ⱼ=y₁ⱼ−y₁₀
      viii. Compute the transformation matrix M that corresponds from moving the image space locations of the triangle [p_{2c}, p₂ᵢ, p₂ⱼ] to those of the triangle [p_{3c}, p₃ᵢ, p₃ⱼ]

$$1. A = [ \begin{matrix}{x}_{2 c} & {x}_{2 i} & {x}_{2 j} \\ {y}_{2 c} & {y}_{2 i} & {y}_{2 j} \\ 1 & 1 & 1\end{matrix} ]$$

$$2. B = [ \begin{matrix}{x}_{3 c} & {x}_{3 i} & {x}_{3 j} \\ {y}_{3 c} & {y}_{3 i} & {y}_{3 j}\end{matrix} ]$$

$$3. M = B * A - 1$$

ix. Perform a transformation on the pixels in the original texture image inside bounding box B₀ using the transformation matrix M. If B₁ is larger than B₀, B₀ may have to be expanded so that the pixel sizes match. Several interpolation methods can be applied to the pixels during the transformation to fill integral pixel value results; this example, a bicubic interpolation over a 4×4 pixel neighborhood is used.
x. Copy the resulting pixels, but crop them to the bounding box B₃=[(0, 0), ((x₁₁−x₁₀), (y₁₁−y₁₀))], which is the size of the face sub-triangle in image space according to the new UV mapping for it, translated to (0, 0) since step 3.d.vii moved the pixel location relative to their bounding box origins.
xi. Copy the resulting cropped pixels into T₂ at starting pixel position (x₁₀, y₁₀). Use a mask during the copy procedure so that pixels other than those inside the triangle [p_{1c}, p₁ᵢ, p₁ⱼ] in T₂ are undisturbed.
4. Rounding, anti-aliasing, and warping effects may have left some pixels in T₂ that lie within a face's parameterization without a new color value. To fix these “holes,” inpaint any holes remaining within a bounding box of all image space values in T₂ that received copied pixels in step 3.d.xi through the loop. In one example, the inpainting techniques described in A. Telea. “An Image Inpainting Technique Based on the Fast Marching Method.” Journal of Graphics Tools 9, 2004, pages 25-36., which is incorporated by reference in its entirety, may be used.

It should be noted that in some cases, the parameterization may have resulted in UV locations outside of the bounding box [(0, 0), (1, 1)]. Mappings outside those bounds indicate to a rendering engine that the texture image should be repeated, but in some examples, using the techniques described herein, the texture image being created is intended to contain the repeats of the pattern along with the shading and the image itself should not be repeated. So for each non-static region, the parameterization from 106 can be resealed to be within the bounding box [(0, 0), (1, 1)], and the shading image from section 110 can be resealed to match accordingly.

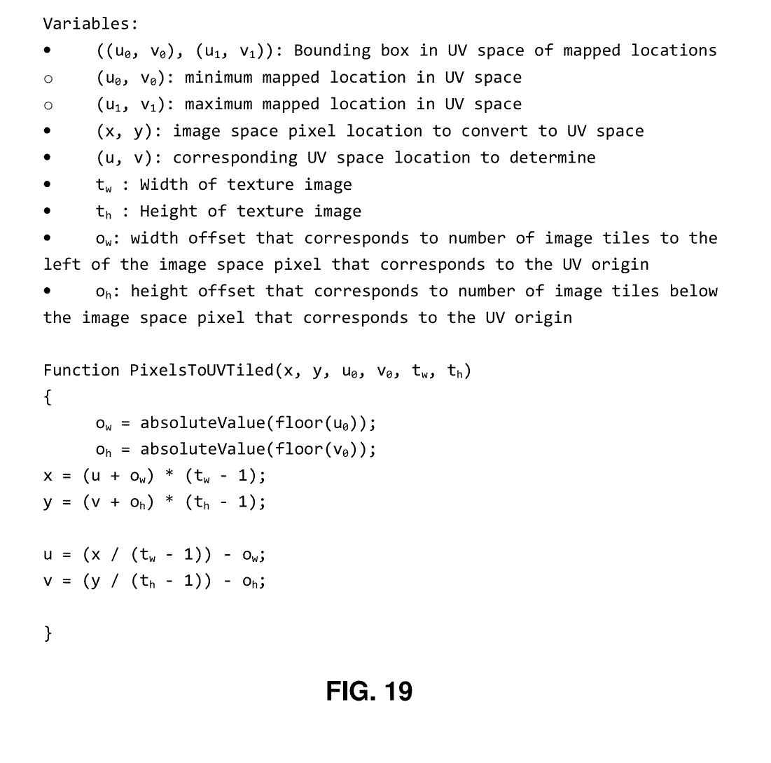

In one example, resealing can be performed as follows:
1. Update B_{φ} so that its bounds correspond to integral pixel locations.
   a. Recall the bounding box in UV space from the parameterization φ₁, computed above: B_{φ}=[(u₀, v₀), (u₁, v₁)]
   b. Convert the minimum point of B_{φ}, (u₀, v₀) to image space (x₀, y₀) using the process detailed in pseudo-code illustrated in FIG. 18.
   c. Convert the maximum point of B_{φ}, (u₁, v₁), to image space (x₁, y₁) using the process detailed in pseudo-code illustrated in FIG. 18.
   d. Round fractions of a pixel for the image space bounding box Bₚ=[(x₀, y₀), (x₁, y₁)] coordinates computed in steps 1.b and 1.c to encompass all fractional values:
      i. x₀=floor (x₀)
      ii. y₀=floor (y₀)
      iii. x₁=ceiling (x₁)
      iv. y₁=ceiling (y₁)
   e. Convert Bₚ back to UV space to update B_{φ} so that its bounds now correspond to integral pixel locations.
      i. Update parametric space (u₀, v₀) in B_{φ} from image space (x₀, y₀) in Bₚ using the process detailed in pseudo-code illustrated in FIG. 19.
      ii. Update parametric space (u₁, v₁) in B_{φ} from image space (x₁, y₁) in Bₚ using the process detailed in pseudo-code illustrated in FIG. 19.
2. Translate and rescale all UV locations for the parameterization of the region's vertices. Translation should move the bounding box of values to begin at location (0, 0) in UV space. Scaling should result in the bounding box of values being in the range [0, 1] for both dimensions of UV space. The scaling factor dm used is the larger of the two ranges of the dimensions so that the ratio of dimension values for each location is maintained.
   a. dm=max((u₁−u₀), (v₁−v₀))
   b. For each vertex i in the mesh region:
      i. Translate and scale its parameterized UV coordinates (uᵢ, vᵢ):
         1. uᵢ=(uᵢ−u₀)/dₘ
         2. vᵢ=(vᵢ−v₀)/dₘ
3. Create a new blank, square texture image T₂ₛ of width dₘ and height dₘ.
4. Copy the pixels in bounding box Bₚ from texture image T₂ into an area of texture image T₂ₛ defined by the bounding box Bₚ₂=[(0,0), (x₁−x₀, y₁−y₀)].
5. Scale T₂ₛ to the desired final texture image size of t_{w} pixels width and tₕ pixels height.

Referring again to FIG. 1, after an unshaded texture image and a shading texture image are constructed, at 1112, the unshaded texture image and a shading texture image are constructed may be composited. In one example, this process may be described as follow, for each non-static region and texture image tile, create the final texture image T₃ using the tiled unshaded image T₁ and the rescaled grayscale shading image T₂ₛ. An example of compositing a shading image and an unshaded image is illustrated in FIG. 4. In one example, the process may be performed as follows:
1. Convert T₁ from RGB to HSV color space
2. Create texture image T₃ to be the same size as T₁ and convert it to the HSV color space.
3. For each pixel i at location (xᵢ, yᵢ) in T₁:
   a. Let the HSV color values of pixel i be (hᵢ, sᵢ, vᵢ)
   b. Copy hᵢ and sᵢ into the H and S color channels, respectively, of T₃ at pixel i at location (xᵢ, yᵢ)
   c. Let the value of the pixel at (xᵢ, yᵢ) in T₂ₛ be vᵢ₂
   d. Let m be the maximum value of a color channel in both T₁ and T₂ₛ. In one example, m=255.
   e. Compute vᵢ₃ for the pixel to incorporate shading from T₂ₛ: vᵢ=round(vᵢ*(vᵢ₂/m))
   f. Copy via into the V channel of T₃ at pixel i at location (xᵢ, yᵢ)
4. Convert T₃ from the HSV color space back to RGB.

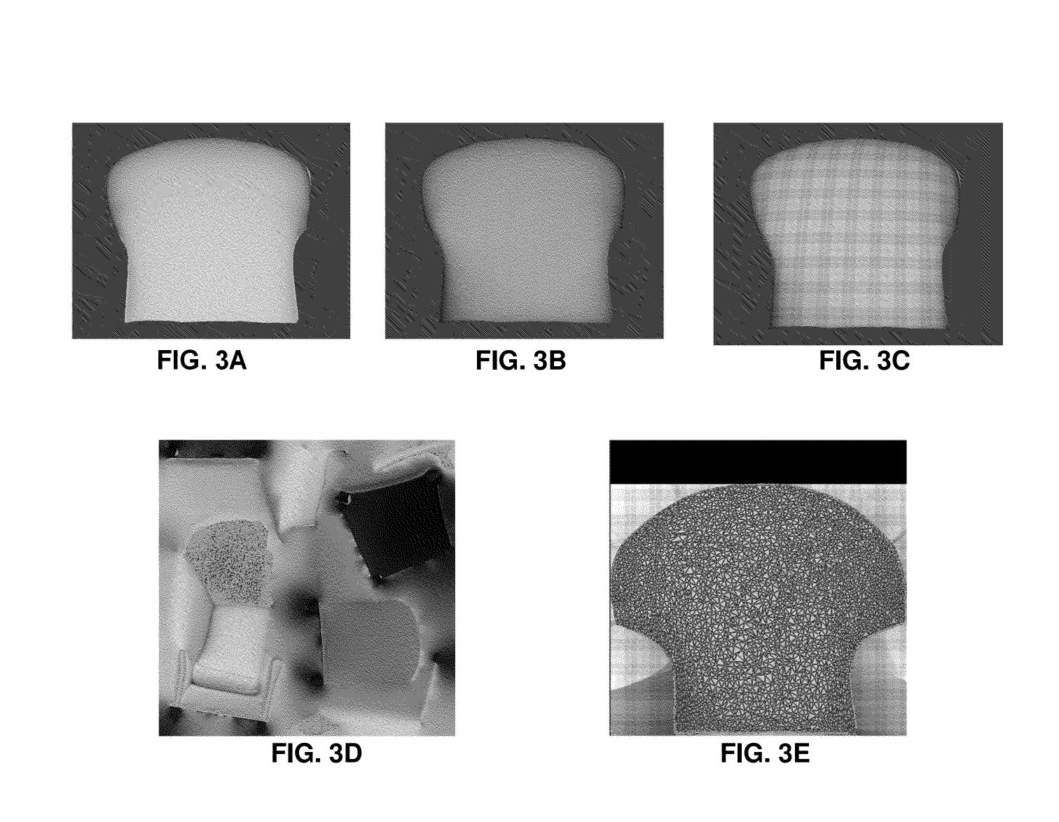

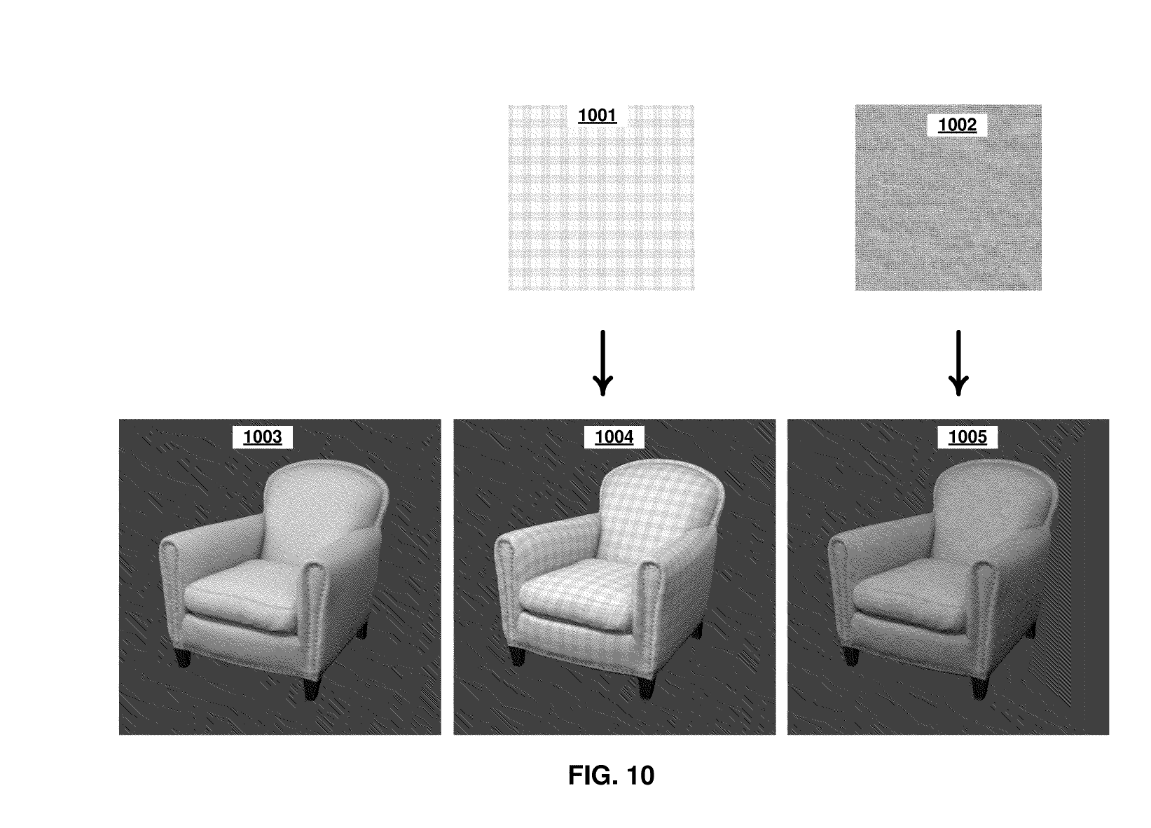

As described above, the techniques described herein may be particularly useful for changing the fabric on 3D models of furniture. FIG. 10 illustrates an example of changing fabric on 3D models of furniture. In the example illustrated in FIG. 10, an example image tile with a checked fabric pattern 1001, an image tile with a woven fabric pattern 1002, a 3D model as it was originally captured and textured 1003, the 3D model re-parameterized and re-textured using the checked fabric pattern 1004, and the 3D model re-parameterized and re-textured using the woven fabric pattern 1005 are illustrated. Further, FIG. 3A-3E illustrate an example un-textured region of the mesh (3A), the region with its originally-captured texture (3B), the region with a new texture (3D), the original parameterization of the region in UV space, and the new parameterization of the region in UV space (3E).

The services, mechanisms, operations and acts shown and described above are implemented, at least in part, by software running on one or more computers or computer systems or user devices. It should be appreciated that each user device is, or comprises, a computer system. Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only. One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

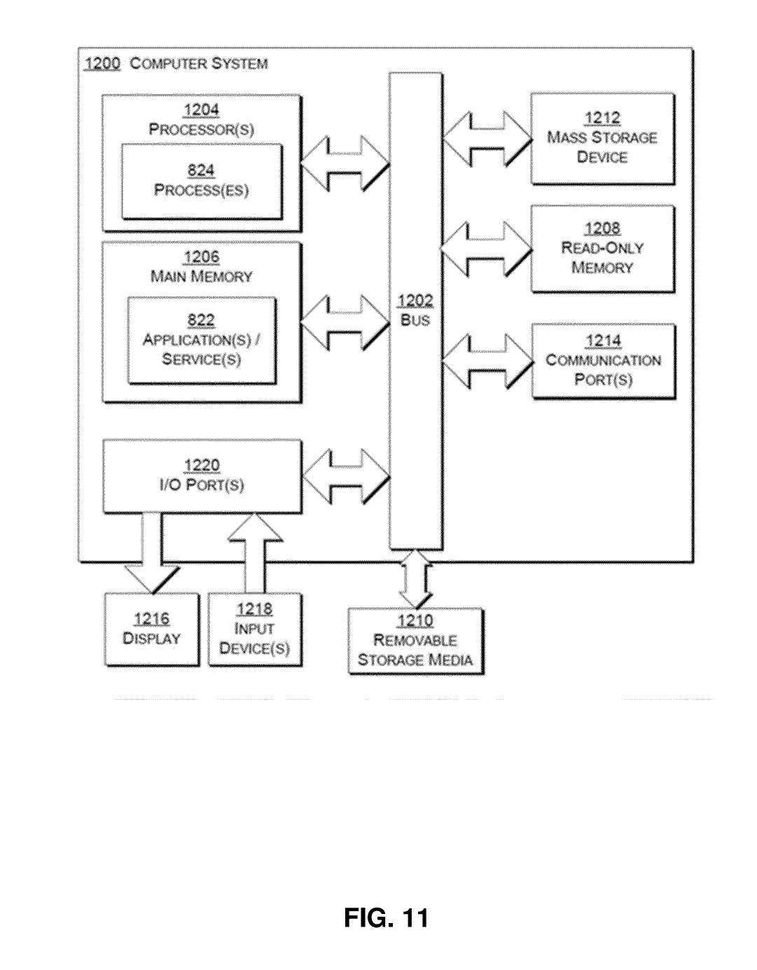

FIG. 11 is a schematic diagram of a computer system 1200 upon which embodiments of the present disclosure may be implemented and carried out.

According to the present example, the computer system 1200 includes a bus 1202 (i.e., interconnect), one or more processors 1204, one or more communications ports 1214, a main memory 1206, optional removable storage media 1210, read-only memory 1208, and a mass storage 1212. Communication port(s) 1214 may be connected to one or more networks (e.g., computer networks, cellular networks, etc.) by way of which the computer system 1200 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1204 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1214 can be any of an RS-232 port for use with a modem based dial-up connection, a 10/100 Ethernet port, a Gigabit port using copper or fiber, or a USB port, and the like. Communications port(s) 1214 may be chosen depending on a network such as a Local Area Network (LAN), a Wide Area Network (WAN), a Content Delivery Network (CDN), or any network to which the computer system 1200 connects. The computer system 1200 may be in communication with peripheral devices (e.g., display screen 1216, input device(s) 1218) via Input/Output (I/O) port 1220. Some or all of the peripheral devices may be integrated into the computer system 1200, and the input device(s) 1218 may be integrated into the display screen 1216 (e.g., in the case of a touch screen).

Main memory 1206 can be Random Access Memory (RAM), or any other dynamic storage device(s) commonly known in the art. Read-only memory 1208 can be any static storage device(s) such as Programmable Read-Only Memory (PROM) chips for storing static information such as instructions for processor(s) 1204. Mass storage 1212 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1202 communicatively couples processor(s) 1204 with the other memory, storage and communications blocks. Bus 1202 can be a PCI/PCI-X, SCSI, a Universal Serial Bus (USB) based system bus (or other) depending on the storage devices used, and the like. Removable storage media 1210 can be any kind of external hard-drives, floppy drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1206 is encoded with application(s) 1222 that support(s) the functionality as discussed herein (an application 1222 may be an application that provides some or all of the functionality of one or more of the mechanisms described herein). Application(s) 1222 (and/or other resources as described herein) can be embodied as software code such as data and/or logic instructions (e.g., code stored in the memory or on another computer readable medium such as a disk) that supports processing functionality according to different embodiments described herein.

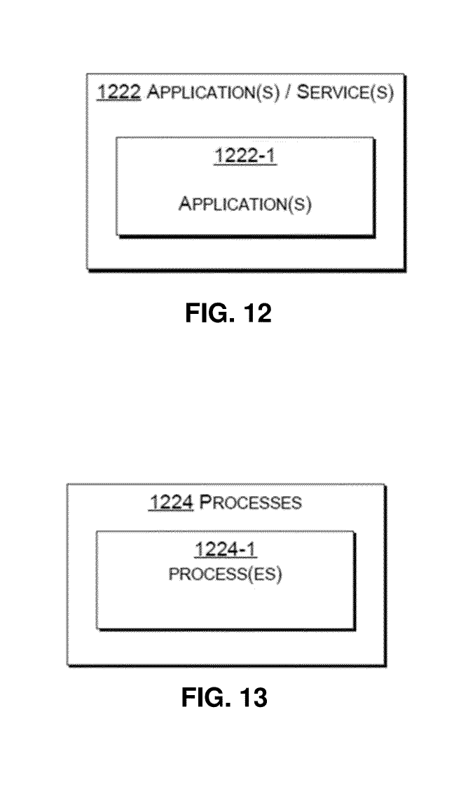

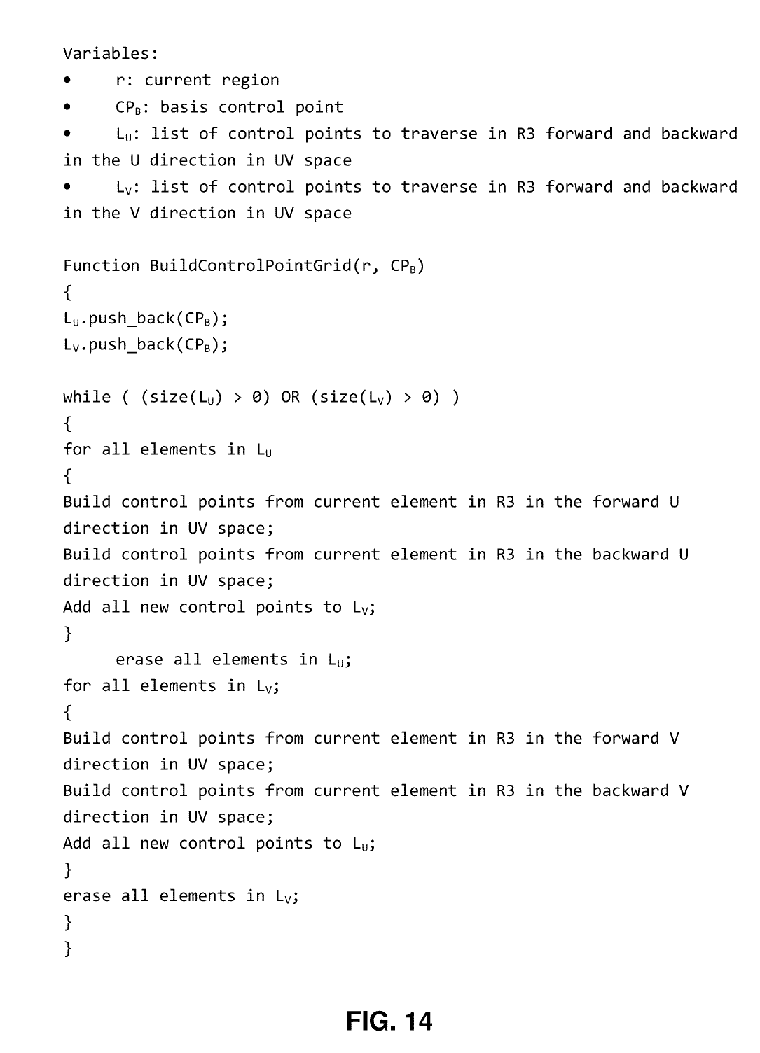

During operation of one embodiment, processor(s) 1204 accesses main memory 1206, e.g., via the use of bus 1202 in order to launch, run, execute, interpret or otherwise perform the logic instructions of the application(s) 1222. Execution of application(s) 1222 produces processing functionality of the service(s) or mechanism(s) related to the application(s). In other words, the process(es) 1224 represents one or more portions of the application(s) 1222 performing within or upon the processor(s) 1204 in the computer system 1200. For example, as shown in FIG. 12 and FIG. 13, process(es) 1224 may include process(es) 1224-1 corresponding to applications 1222-1.

It should be noted that, in addition to the process(es) 1224 that carries (carry) out operations as discussed herein, other embodiments herein include the application 1222 itself (i.e., the un-executed or non-performing logic instructions and/or data). The application 1222 may be stored on a computer readable medium (e.g., a repository) such as a disk or in an optical medium. According to other embodiments, the application 1222 can also be stored in a memory type system such as in firmware, read only memory (ROM), or, as in this example, as executable code within the main memory 1206 (e.g., within Random Access Memory or RAM). For example, application 1222 may also be stored in removable storage media 1210, read-only memory 1208, and/or mass storage device 1212.

Those skilled in the art will understand that the computer system 1200 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A method for mapping an image tile to an object, the method comprising:
receiving a virtual model of an object;
generating a plurality of control points for the virtual model;
generating a UV mapping based on the generated control points;
receiving an image tile; and
generating a texture image based on the image tile.

2. The method of claim 1, wherein the virtual model of an object includes a region of an item of furniture.

3. The method of claim 1, wherein generating a plurality of control point includes creating a basis control point including associated gradient vectors and iteratively creating additional control points based on the basis control point.

4. The method of claim 3, wherein creating additional control points includes traversing an isoparametric curve.

5. The method of claim 4, wherein creating additional control points includes creating control points on edges of a mesh that lie along the isoparametric curve.

6. The method of claim 1, wherein generating a UV mapping based on the plurality of control points includes building a set of linear equations, adding roughness to the set of linear equations, and finding a solution to the set of linear equations.

7. The method of claim 1, wherein generating a texture image based on the image tile includes creating an unshaded texture image.

8. The method of claim 7, wherein generating a texture image based on the image tile includes creating a shading texture image.

9. The method of claim 8, wherein creating a shading texture image includes performing a transformation on an original texture image.

10. The method of claim 8, wherein generating a texture image based on the image tile includes compositing the unshaded texture image and the shading texture image.

11. A non-transitory computer-readable storage medium comprising instructions stored thereon that upon execution cause one or more processors of a device to:
receive a virtual model of an object;
generate a plurality of control points for the virtual model;
generate a UV mapping based on the generated control points;
receive an image tile; and
generate a texture image based on the image tile.

12. The non-transitory computer readable medium of claim 11, wherein the virtual model of an object includes a region of an item of furniture.

13. The non-transitory computer readable medium of claim 11, wherein generating a plurality of control point includes creating a basis control point including associated gradient vectors and iteratively creating additional control points based on the basis control point.

14. The non-transitory computer readable medium of claim 13, wherein creating additional control points includes traversing an isoparametric curve.

15. The non-transitory computer readable medium of claim 14, wherein creating additional control points includes creating control points on edges of a mesh that lie along the isoparametric curve.

16. The non-transitory computer readable medium of claim 11, wherein generating a UV mapping based on the plurality of control points includes building a set of linear equations, adding roughness to the set of linear equations, and finding a solution to the set of linear equations.

17. The non-transitory computer readable medium of claim 11, wherein generating a texture image based on the image tile includes creating an unshaded texture image.

18. The non-transitory computer readable medium of claim 17, wherein generating a texture image based on the image tile includes creating a shading texture image.

19. The non-transitory computer readable medium of claim 18, wherein creating a shading texture image includes performing a transformation on an original texture image.

20. The non-transitory computer readable medium of claim 18, wherein generating a texture image based on the image tile includes compositing the unshaded texture image and the shading texture image.
